(19) United States
(12) Patent Application Publication
(10) Pub. No.: US 2014/0316956 A1
(43) Pub. Date: Oct. 23, 2014

(54) Cost Allocation System, Method and Device Having Multiple Data Collection Modules with Hierarchal Structures

(71) Applicant: CUBE BILLING, LLC, Dallas, TX (US)

(72) Inventor: BRENT R. LOEWEN, DALLAS, TX (US)

(73) Assignee: Cube Billing, LLC, Dallas, TX (US)

(21) Appl. No.: 13/868,876

(22) Filed: Apr. 23, 2013

(51) Int. Cl. G06Q 30/04

(52) U.S. Cl. CPC G06Q 30/04
USPC 705/34

(57) ABSTRACT

A system has a hierarchal data structure for at least one offering, at least one provider of the offering and at least one receiver of the offering. In one embodiment, the system receives an input for a transaction involving the provider and receiver. The system generates cost information, which is available to system users.

### COPYRIGHT NOTICE

A portion of the disclosure of this patent document contains or may contain material which is subject to copyright protection. The copyright owner has no objection to the photocopy reproduction by anyone of the entire patent document in exactly the form it appears in the Patent and Trademark Office patent file or records, but otherwise reserves all copyrights whatsoever.

### BACKGROUND

A company, depending upon its size, may have internal divisions, such as business units and departments. For example, a consumer electronics manufacturer may have a videogame business unit, a smartphone business unit, an information technology (IT) department, a marketing department, a sales department, a legal department and an accounting department.

This type of company may provide different resources to its divisions depending upon their individual requirements. For example, the company's IT department may provide the other divisions with computer hardware, software, database access and technical support. The marketing department may provide the business units with brochure design services for their new product launches.

There is internal billing software designed to track the consumption of resources by the divisions of a company. One division of a company receives an order from another division, and the internal billing software produces a bill based on that order. For example, one of the business units of the consumer product manufacturer may receive a bill. The bill may show a cost of $20,000 for graphic design services performed by the manufacturer's marketing department for that business unit. The manufacturer may monitor this information to help run its business.

There are several disadvantages with the known internal billing software. First, the software is not designed to be easily accessible to each of the involved divisions. As a result, an employee, after generating a bill, might have to exit the software program, attach the bill to an email, and then email that bill to other employees. This can be time consuming and inefficient for a company. This can also expose the company to data security risks. Second, the internal billing software does not provide the billing data at different levels of information which are more useful to the different divisions. Consequently, the company can be hindered due to lack of knowledge, lack of internal communication and lack of internal transparency regarding its cost drivers.

Therefore, there is a need to overcome, or otherwise lessen the effects of, these disadvantages and shortcomings.

### SUMMARY

The cost allocation system, in one embodiment, enables an organization to monitor costs driven by the organization's internal divisions. To generate a transaction, the system couples together multiple components, including a provider division, a receiver division, and an offerings portfolio of products or services. In one embodiment, each of these components has a hierarchal data structure. The hierarchal structures assist users in locating cost information which is helpful to them. The system has different categories of user profiles, providing different degrees of authority for administrators, users of the provider division and users of the receiver division.

The system is operable to generate statements or invoices. In one embodiment, the statements, including showback statements, chargeback statements and cost statements, are prepared to provide information about the costs consumed by the receiver. The invoices, on the other hand, are generated for payment by the receiver.

It should be understood that the organization can also use the system to bill its external customers. In one embodiment, the cost allocation system enables the organization to invoice its customers for the customers' purchase orders. To generate a transaction, the system couples together multiple components, including a provider division, the customer as the receiver, and the organization's offerings portfolio.

To operate the system, the organization first populates the hierarchal structures with data. This involves entering, uploading or transferring descriptors related to the provider, receiver and offerings. The system collects and stores the descriptors in multiple hierarchal modules, including a provider hierarchal module, a receiver hierarchal module and an offerings hierarchal module. To initiate a transaction, the user inputs or loads transactional data, and the system generates the transaction with the resulting cost information. Users can track, preview, modify and terminate pending transactions before the system processes them. Once processed, users can access the cost information and view reports with information filterable by the hierarchy levels and other criteria.

In one embodiment, the system includes a data storage device accessible by a processor. The data storage device stores an offering module, a provider module, a receiver module and a plurality of computer-readable instructions. The offering module defines or specifies a plurality of levels of offering data fields organized in a hierarchal arrangement. Each one of the offering data fields is fillable with an offering descriptor. The offering descriptors are associated with an offering, including, but not limited to, a product or service.

The provider module defines or specifies a plurality of levels of provider data fields organized in a hierarchal arrangement. Each one of the provider data fields is fillable with a provider descriptor. The provider descriptors are associated with a provider. The provider is capable of providing one or more of the offerings to a receiver.

The receiver module defines or specifies a plurality of levels of receiver data fields organized in a hierarchal arrangement. Each one of the receiver data fields is fillable with a receiver descriptor. The receiver descriptors are associated with the receiver.

The computer-readable instructions are executable by the processor to: (a) receive at least one of the offering descriptors, at least one of the provider descriptors and at least one of the receiver descriptors; (b) receive a price; and (c) generate cost information.

In one embodiment, the provider is a division of an organization, and the receiver is another division of the same organization. In another embodiment, the provider is a first organization, and the receiver is a second organization. The second organization is an external customer of the first organization.

In one embodiment, the computer-readable instructions are executable by the processor to receive an output request related to the cost information. The output request specifies at least one of a plurality of selectable filter settings. The selectable filter settings include: (a) an offering descriptor filter setting; (b) a provider descriptor filter setting; and (c) a receiver descriptor filter setting. The processor is operable to generate a visible output in response to the output request. The visible output includes the cost information in a format based on the specified filter setting.

Additional features and advantages of the present invention are described in, and will be apparent from, the following Brief Description of the Figures and Detailed Description.

### BRIEF DESCRIPTION OF THE FIGURES

FIG. 1 is a schematic block diagram illustrating one embodiment of the system coupled to a network accessible to users.

FIG. 2 is a schematic block diagram illustrating an organization's internal use of the system.

FIG. 3 is a schematic block diagram illustrating an organization's use of the system for outside organizations.

FIG. 4 is a schematic block diagram illustrating one embodiment of the system having a data storage device.

FIG. 5 is a schematic block diagram illustrating one example of one embodiment of the provider hierarchal module of the system.

FIG. 6 is a view of one example of one embodiment of a provider setup interface of the system.

FIG. 7 is a schematic block diagram illustrating one example of one embodiment of the receiver hierarchal module of the system.

FIG. 8 is a view of one example of one embodiment of a receiver setup interface of the system.

FIG. 9 is a schematic block diagram illustrating one example of one embodiment of the offerings hierarchal module of the system.

FIG. 10 is a view of one example of one embodiment of an offerings setup interface of the system.

FIG. 11 is a Venn diagram illustrating one embodiment of the relationship between the different levels of descriptor data fields of the system.

FIG. 12 is a view of one example of one embodiment of a rate interface of the system.

FIG. 13 is a view of one example of one embodiment of a transaction interface of the system.

FIG. 14 is a view of one example of one embodiment of an Enterprise Resource Planning (ERP) interface of the system.

FIG. 15 is a view of another example of one embodiment of the ERP interface of the system.

FIG. 16 is a view of one example of one embodiment of the wizard-type user setup interface of the system.

FIG. 17 is a view of one example of one embodiment of the access control interface of the system.

FIG. 18 is a schematic block diagram illustrating one example of the system's method of operation.

FIG. 19 is a schematic block diagram illustrating another example of the system's method of operation involving an ERP system.

FIG. 20 is a schematic block diagram illustrating another example of the system's method of operation involving outputs from the system and ERP-related outputs.

FIG. 21 is a schematic block diagram illustrating another example of the system's method of operation involving external vendors.

FIG. 22 is a view of one example of one embodiment of the transaction cancellation interface of the system.

FIG. 23 is a view of one example of one embodiment of the system's visible output.

FIG. 24 is a view of one example of another embodiment of the system's visible output.

### DETAILED DESCRIPTION

### System

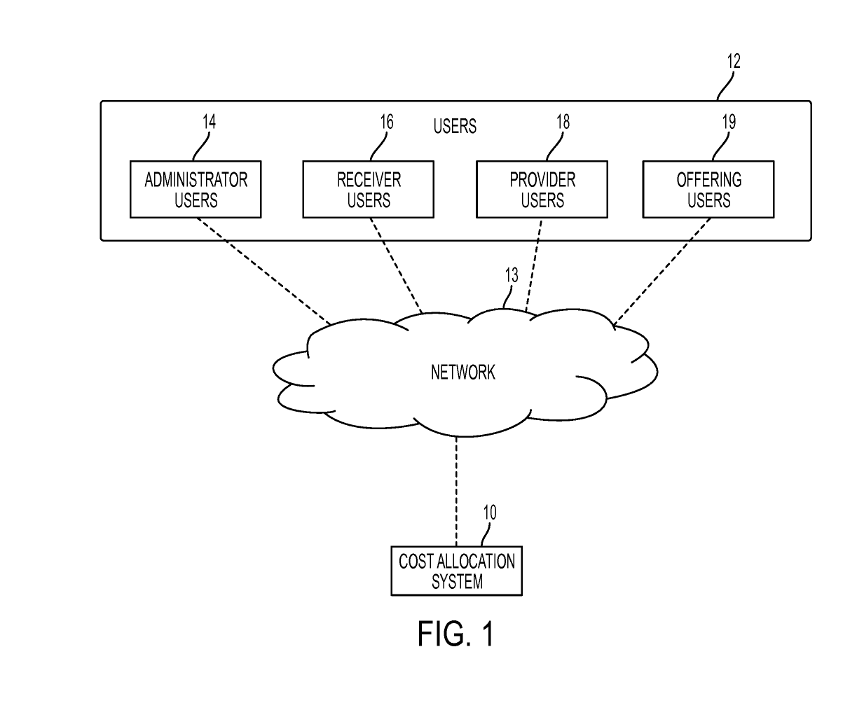

Referring to FIG. 1, in one embodiment, the cost allocation system 10 is accessible by users 12 over a network 13, including, but not limited to, the Internet, a local area network, a wide area network or any other suitable data network or communication channel. In one embodiment, users 12 use network access devices to access the network 13. Depending upon the embodiment, the network access devices can include computers, smartphones or other electronic devices.

Users 12 include administrator users 14, receiver users 16, provider users 18 and offering users 19. These four classes of users 12 are associated with different profiles and privileges as described in detail below. The users, depending upon their privileges, can access the system 10 to initiate a transaction or access cost information related to the completed transaction.

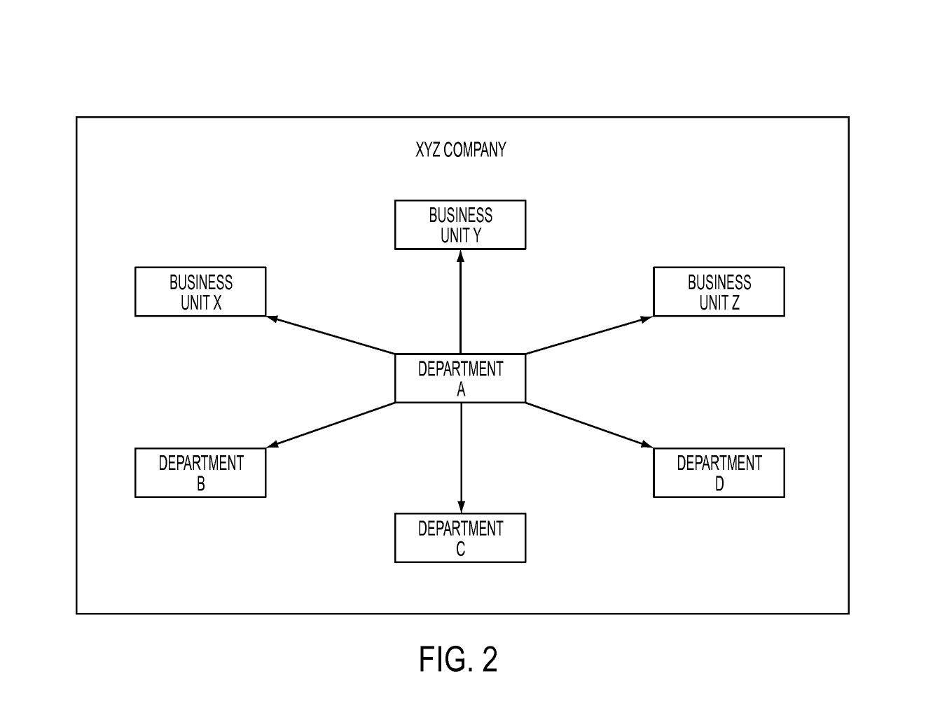

The system 10 is usable by an organization or person, including, but not limited to, a company, business, partnership, sole proprietorship, individual person, for-profit entity, non-profit entity, association, group, club or any other entity. In the example illustrated in FIG. 2, a single organization, the XYZ Company, uses the system 10 to track the cost drivers within its company. In this example, the XYZ Company has three internal divisions, the business units X, Y and Z. Each business unit pertains to a different product line. The XYZ Company also has four more internal divisions, the activity centers or departments A, B, C and D. Department A is the information technology (IT) department. Department A provides IT hardware, software, database access and support to business units X, Y and Z as well as departments B, C and D. When department A provides an IT resource, the system 10 allocates the cost of that resource to the requesting business unit or department.

A division of an organization can include, but is not limited to, a department, a business unit, a group, a center, an unincorporated division, an incorporated division, a subsidiary, a parent, an affiliated entity, an entity having a portion of its equity owned by the organization, a partner or a contractor.

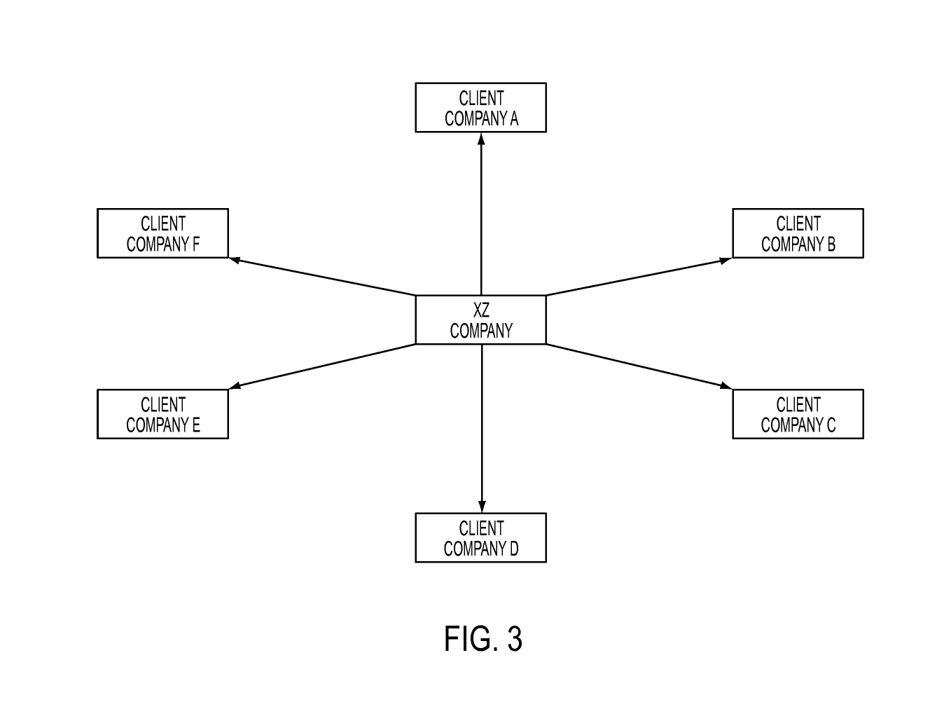

In the example illustrated in FIG. 3, several organizations use the system 10, including the XZ Company and its business customers or clients, namely companies A-F. In this example, the XZ Company sells photocopying paper and ink supplies to its clients, companies A-F. The XZ Company also performs photocopy machine maintenance services for companies A-F. The system 10 issues invoices to the requesting companies for the price of the products and services which they received. In this way, the system allocates the cost of the ordered products and services to XZ Company's clients.

It should be appreciated that the XY Company can also use the system 10 to allocate costs directly to end-user customers, that is, the customers who actually use or consume the ordered products or services. Depending upon the scenario, the end-user customer may be a customer of a client company A-F, or the end-user customer may be a customer of the XY Company. The system 10 is operable to invoice the end-user customers. The system 10 is also operable to generate cost statements for the end-user customers or to the regions, locations, divisions or cost centers of the end-user customers.

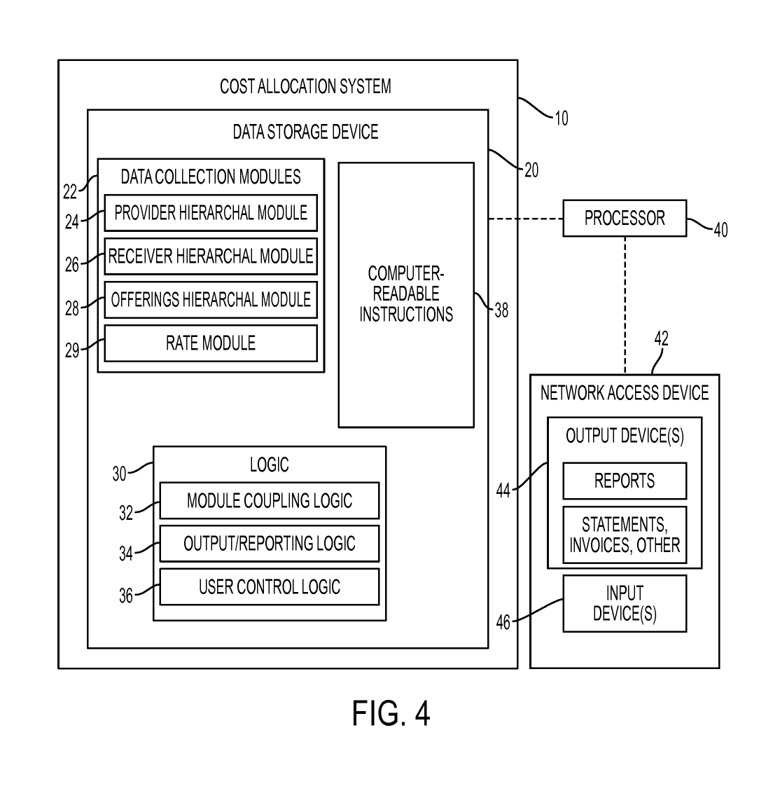

In one embodiment illustrated in FIG. 4, the system 10 includes a data storage device 20. The data storage device 20 includes a plurality of data collection modules 22. The data collection modules 22 include a provider module or provider hierarchal module 24, a receiver module or receiver hierarchal module 26, an offerings module or offerings hierarchal module 28, and a price or rate module 29.

The data storage device 20 also includes logic 30. Logic 30 includes: (a) module coupling logic 32 operable to couple together, the modules 24, 26, 28 and 29 through commands and conditional instructions; (b) output or reporting logic 34 operable for generating outputs, including graphical user interfaces, visuals, statements, reports, invoices, notices, alerts and audio output; and (c) user control logic 36 operable for controlling the degree of user access and user control for the system 10.

The data storage device 20 also stores computer code or computer-readable instructions 38. A server or processor 40 executes the instructions 38 to process data in accordance with the data collection modules 22 and logic 30. A user, operating a network access device 42, can access the system 10 over the network 13. In one embodiment, the network access device 42 has an output device 44, such as a display screen, and an input device 46, such as a touchscreen or keyboard. The user can provide inputs to populate the data collection modules 22 with data. The user can also receive outputs through the output device 44, such as cost reports, statements or invoices.

The provider hierarchal module 24 serves as a repository for information pertaining to one or more providers. Depending upon the circumstances, the provider can be an organization or a division of an organization. The provider could be an organization if the organization were to use the system in connection with its supply of offerings to external parties, such as its customers.

On the other hand, the provider could be a division of an organization if the organization were to use the system 10 in connection with its supply of offerings to other divisions of the organization. In that circumstance, the organization may have several divisions responsible for providing offerings to other divisions of the organization. Each division which acts in this supplier role would be considered a provider. Therefore, the organization would set-up each of these divisions as a separate provider within the provider hierarchal module 24.

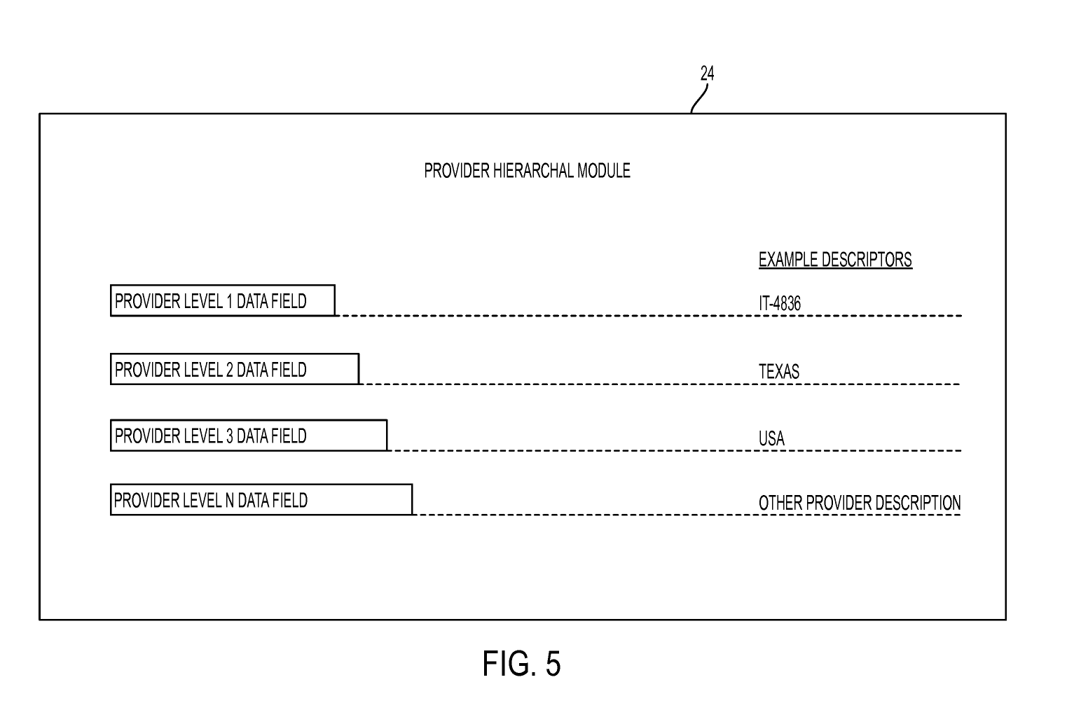

In one embodiment illustrated in FIG. 5, the provider hierarchal module 24 includes a data structure for collecting and organizing data related to one or more providers. An administrator user 12 can enter, upload, populate or otherwise fill the provider hierarchal module 24 with attributes or descriptors of one or more providers.

When setting-up the system 10 for the organization's use, the organization's administrator may enter desired descriptors in the provider hierarchal module 24 in accordance with the organization's preferences. As illustrated in FIG. 5, in one embodiment, the provider hierarchal module 24 includes a plurality of different levels of provider descriptor fields, including provider level 1 data field, provider level 2 data field and provider level 3 data field. The provider hierarchal module 24 also includes one or more additional provider descriptor data field levels, indicated by “provider level N data field,” where “N” represents a number greater than three. These data fields are associated with varying degrees of specificity of provider description or attributes.

Level 1 is associated with a relatively high specificity, and the specificity decreases with each additional level toward level N. In the illustrated example, the provider is IT-4836, one of several IT departments of the organization. The user populated or filled the level 1 data field with the organization's unique identification code for that IT department, IT-4836. The user then populated or filled the level 2 data field with the sub-region in which the department is located, which, in this example, is Texas. Then, the user populated or filled the level 3 data field with the region in which the department is located, which, in this example, is USA. The user had the option of adding additional levels of descriptors as indicated by the level N data field shown in FIG. 5. In this example, the user elected not to use any levels beyond the level 3 data field.

It should be appreciated that, for the system 10 to generate cost information for a given provider, the user is not required to enter descriptors for level 2, 3 or N. In one embodiment, the entry of a single descriptor for the level 1 field is sufficient for generating cost information related to the provider.

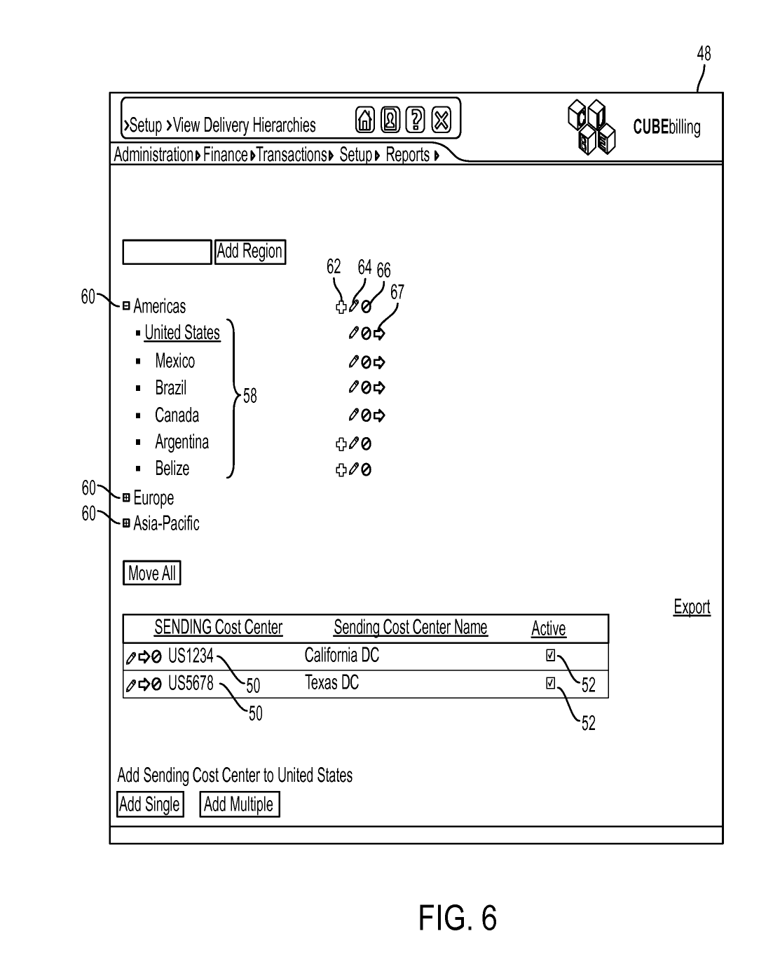

In one embodiment, the system 10 generates a provider setup interface, such as the example provider setup interface 48 shown in FIG. 6. The provider setup interface 48, in this example, displays two provider level 1 data fields 50, populated with provider identification codes US1234 for the California datacenter and US5678 for the Texas datacenter. These codes are the provider level 1 descriptors. The provider setup interface 48 also displays, next to each field 50, an active indicator or active box 52. The user may activate a provider by checking the active box 52, or the user may deactivate a provider by unchecking the active box 52. The provider setup interface 48 also displays six provider level 2 data fields 58 populated with sub-regions, United States, Mexico, Brazil, Canada, Argentina and Belize. These sub-region names are the provider level 2 descriptors. The provider setup interface 48 also displays three provider level 3 data fields 60 populated with regions, Americas, Europe and Asia-Pacific. These regions are the provider level 3 descriptors.

For each descriptor, the provider setup interface 48 displays an add link 62, edit link 64, delete link 66 and move link or hierarchy change link 67 as illustrated in FIG. 6. The add link 62 enables the user to add a new descriptor within one of the data fields. The edit link 64 enables the user to edit a descriptor within one of the data fields. The delete link 66 enables the user to delete a descriptor. The hierarchy change link 67 enables the user to drag and drop children of one hierarchy into a different hierarchy. For example, the user may want to separate North America from South America. The user may rename “Americas” to “North America.” Then, the user may create a new region, “South America.” The user may then use the move links or hierarchy change links 67 to separately drag the regions, Mexico, Brazil, Canada, Argentina and Belize to the South America name and drop them there.

After the administrator user enters the provider descriptors in the provider hierarchal module 24, the user may then set-up one or more receivers within the receiver hierarchal module 26. Depending upon the circumstances, a receiver can be an external organization or a division of an organization. The receiver would be an external organization if the receiver were a separate entity, such as the organization's customer.

On the other hand, the receiver would be a division of the organization if the ordering entity were a division of the organization. In that circumstance, the organization may have several divisions which consume offerings provided by the organization's providers. Each of the consuming divisions would be considered a receiver. Therefore, the organization would set-up each of these divisions as a separate receiver within the receiver hierarchal module 26.

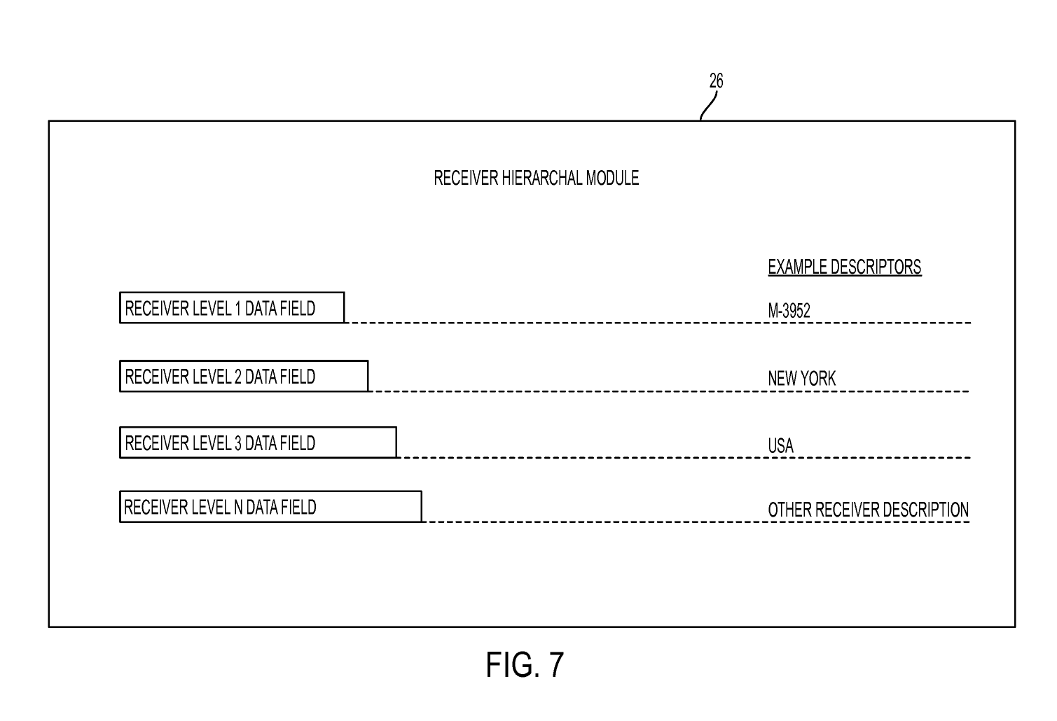

In one embodiment illustrated in FIG. 7, the receiver hierarchal module 26 includes a data structure for collecting and organizing data related to one or more receivers. An administrator user 12 can enter, upload, populate or otherwise fill the receiver hierarchal module 26 with attributes or descriptors of one or more receivers.

When setting-up the system 10 for the organization's use, the organization's administrator may enter desired descriptors in the receiver hierarchal module 26 in accordance with the organization's preferences. As illustrated in FIG. 7, in one embodiment, the receiver hierarchal module 26 includes a plurality of different levels of receiver descriptor fields, including receiver level 1 data field, receiver level 2 data field and receiver level 3 data field. The receiver hierarchal module 26 also includes one or more additional receiver descriptor data field levels, indicated by “receiver level N data field,” where “N” represents a number greater than three. These data fields are associated with varying degrees of specificity of receiver description or attributes.

Level 1 is associated with a relatively high specificity, and the specificity decreases with each additional level toward level N. In the illustrated example, the receiver is M-3952, one of several marketing departments of the organization. The user populated or filled the level 1 data field with the organization's unique identification code for that marketing department, M-3952. This marketing department code is the receiver level 1 descriptor. The user then populated or filled the level 2 data field with the sub-region in which the department is located, which, in this example, is New York. This state, New York, is the receiver level 2 descriptor. Then, the user populated or filled the level 3 data field with the region in which the department is located, which, in this example, is USA. This country, USA, is the receiver level 3 descriptor. The user had the option of adding additional levels of descriptors as indicated by the level N data field shown in FIG. 7. In this example, the user elected not to use any levels beyond the level 3 data field.

It should be appreciated that, for the system 10 to generate cost information for a given receiver, the user is not required to enter descriptors for level 2, 3 or N. In one embodiment, the entry of a single descriptor for the level 1 field is sufficient for generating cost information related to the receiver.

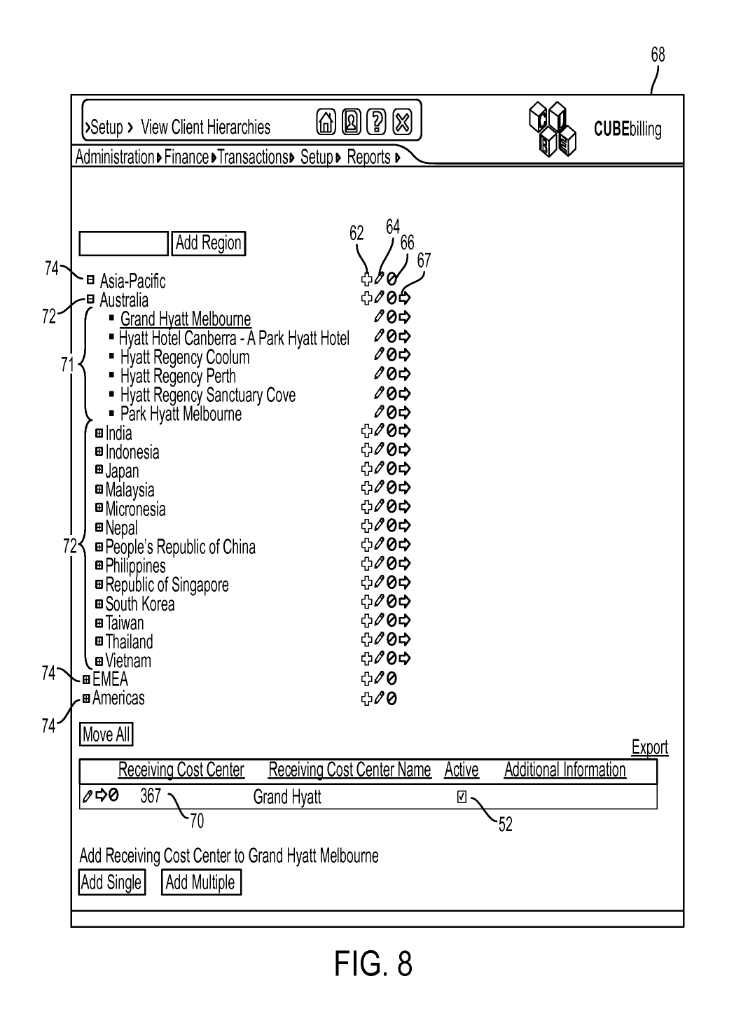

In one embodiment, the system 10 generates a receiver setup interface, such as the example receiver setup interface 68 shown in FIG. 8. The receiver setup interface 68, in this example, displays one receiver level 1 data field 70, populated with receiver identification code 367 for the Grand Hyatt hotel. The receiver setup interface 68 also displays, next to field 70, the active indicator or active box 52.

The receiver setup interface 68 displays six receiver level 2 data fields 71 populated with the names, Grand Hyatt Melbourne, Hyatt Hotel Canberra—A Park Hyatt Hotel, Hyatt Regency Coolum, Hyatt Regency Perth, Hyatt Regency Sanctuary Cove and Park Hyatt Melbourne. The receiver setup interface 68 also displays fourteen receiver level 3 data fields 72 populated with the sub-regions, Australia, India, Indonesia, Japan, Malaysia, Micronesia, Nepal, People's Republic of China, Philippines, Republic of Singapore, South Korea, Taiwan, Thailand and Vietnam. The receiver setup interface 68 displays three provider level 4 data fields 74 populated with regions, Asia-Pacific, EMEA and Americas. For each descriptor, the receiver setup interface 68 displays the add link 62, edit link 64, delete link 66 and hierarchy change link 67.

After the administrator user enters the receiver descriptors in the receiver hierarchal module 26, the user may populate or fill the offerings hierarchal module 28 with the information of the organization's offerings. The offerings hierarchal module 28 serves as a repository for information pertaining to the organization's offerings. In one embodiment, the provider has its administrator user set-up its portfolio of offerings. The organization's offerings can include its products, including, but not limited to, materials, supplies, devices, equipment, goods or other items. Also, the organization's offerings can includes its services, including, but not limited to, maintenance, repair, leasing, hosting, subscription, training, installation, deployment, consultation, help, support, warranty or other activities.

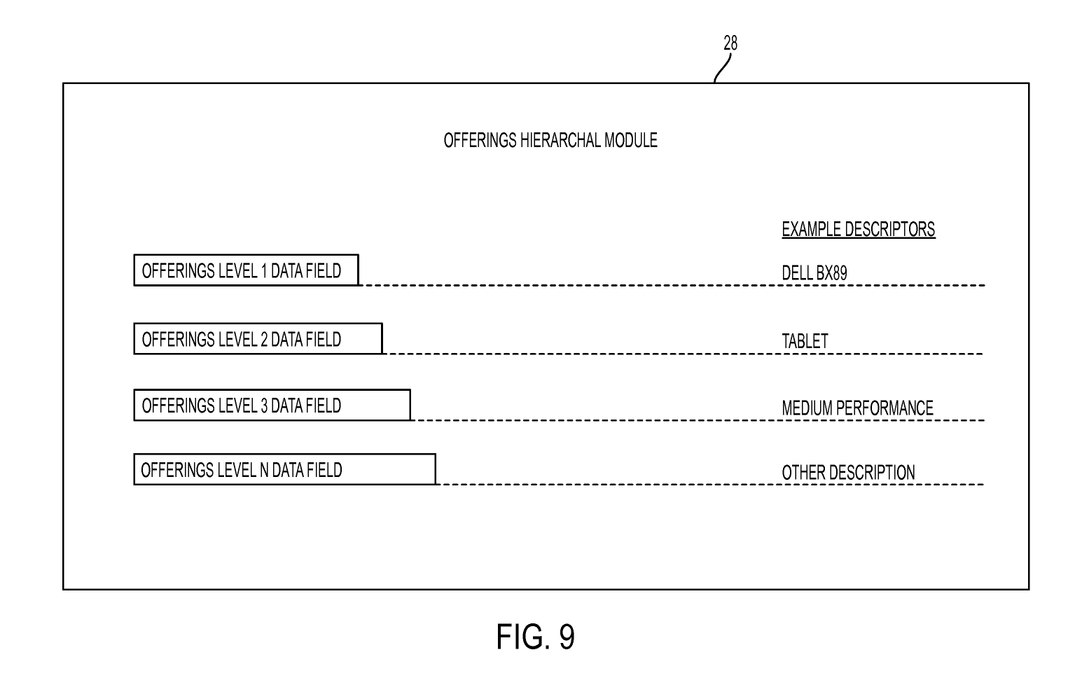

In one embodiment illustrated in FIG. 9, the offerings hierarchal module 28 includes a data structure for collecting and organizing data related to the organization's offerings. The administrator user can enter, upload, populate or otherwise fill the offerings hierarchal module 28 with attributes or descriptors of its offerings. For example, the organization may have an IT warehouse stocked with various types and models of computers for use by the organization's employees, including different models of Dell®, HP® and Lenovo® computers. The computer models may have various form factors, including desktop, all-in-one, laptop and tablet. The models may also have various degrees of processing power for the different categories of employees. For example, the organization may have a policy for assigning high performance computers to its engineers and graphics designers, and the organization may assign medium performance computers to its sales staff, lawyers and accountants.

When setting-up the system 10 for the organization's use, the organization's administrator may enter desired descriptors in the offerings hierarchal module 28 in accordance with the organization's preferences. As illustrated in FIG. 9, in one embodiment, the offerings hierarchal module 26 includes a plurality of different levels of offerings descriptor fields, including offerings level 1 data field, offerings level 2 data field and offerings level 3 data field. The offerings hierarchal module 28 also includes one or more additional offerings descriptor data field levels, indicated by “offerings level N data field,” where “N” represents a number greater than three. These data fields are associated with varying degrees of specificity of offering description or attributes.

Level 1 is associated with a relatively high specificity, and the specificity decreases with each additional level toward level N. In the illustrated example, the offering is a Dell® computer. The user populated or filled the level 1 data field with a specific computer model number, which, in this example, is Dell BX89. The model name is the offerings level 1 descriptor. The user then populated or filled the level 2 data field with the form factor of the computer, which, in this example, is tablet. This form factor name is the offerings level 2 descriptor. Then, the user populated or filled the level 3 data field with the processing power of the computer, which, in this example, is Medium Performance. This processing power level, Medium Performance, is the offerings level 3 descriptor. The user had the option of adding additional levels of offerings descriptor fields as indicated by the level N data field shown in FIG. 9. In this example, the user elected not to use any levels beyond the level 3 data field.

It should be appreciated that, for the system 10 to generate cost information for a particular offering, the user is not required to enter descriptors for level 2, 3 or N. In one embodiment, the entry of a single descriptor for the level 1 field is sufficient for generating cost information related to the entered offering.

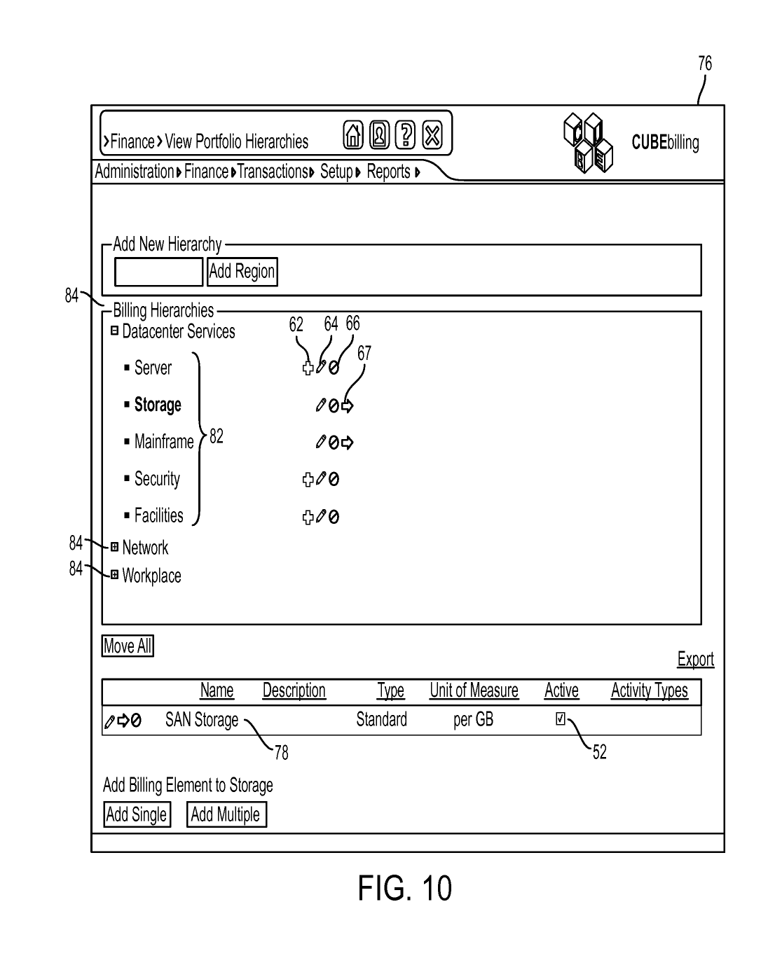

In one embodiment, the system 10 generates an offerings setup interface, such as the example offerings setup interface 76 shown in FIG. 10. The offerings setup interface 76, in this example, displays one offerings level 1 data field 78, populated with the offerings name, SAN Storage. The offerings setup interface 76 also displays, next to field 78, the active indicator or active box 52.

The offerings setup interface 76 displays five provider level 2 data fields 82 populated with the names, Server, Storage, Mainframe, Security and Facilities. The offerings setup interface 76 displays three offerings level 3 data fields 84 populated with the offering categories, Datacenter Services, Network and Workplace. For each descriptor, the offerings setup interface 76 displays the add link 62, edit link 64, delete link 66 and hierarchy change link 67.

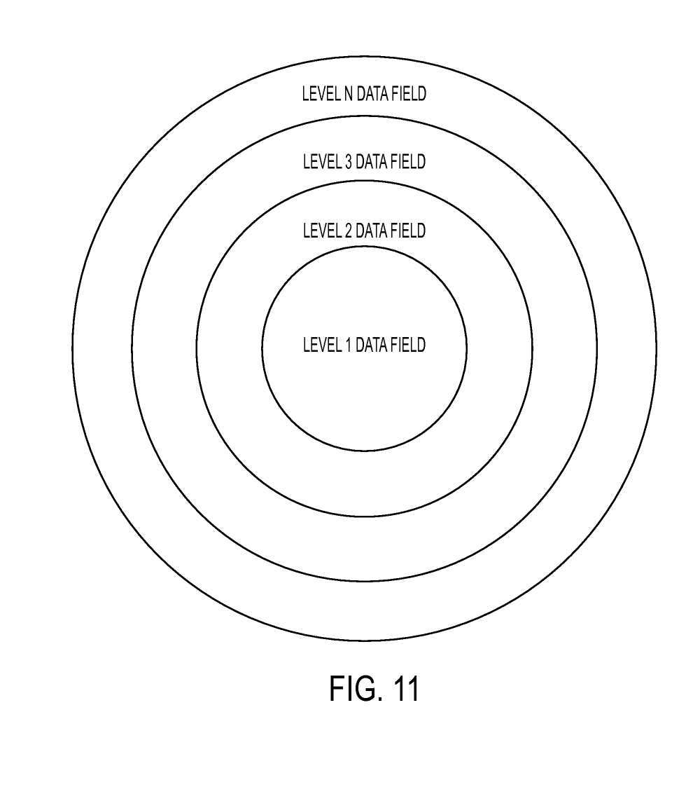

Referring to FIG. 11, in one embodiment, the hierarchal structure of each of the modules 24, 26 and 28 corresponds to the logic of a Venn diagram. As illustrated, the level 3 descriptor data field is a child or subset of the level N descriptor data field. The level 2 descriptor data field is a child or subset of the level 3 descriptor data field. The level 1 descriptor data field is a child or subgroup of the level 2 descriptor data field. The degree of specificity for a provider, receiver or offering, decreases in moving from level 1 toward level N.

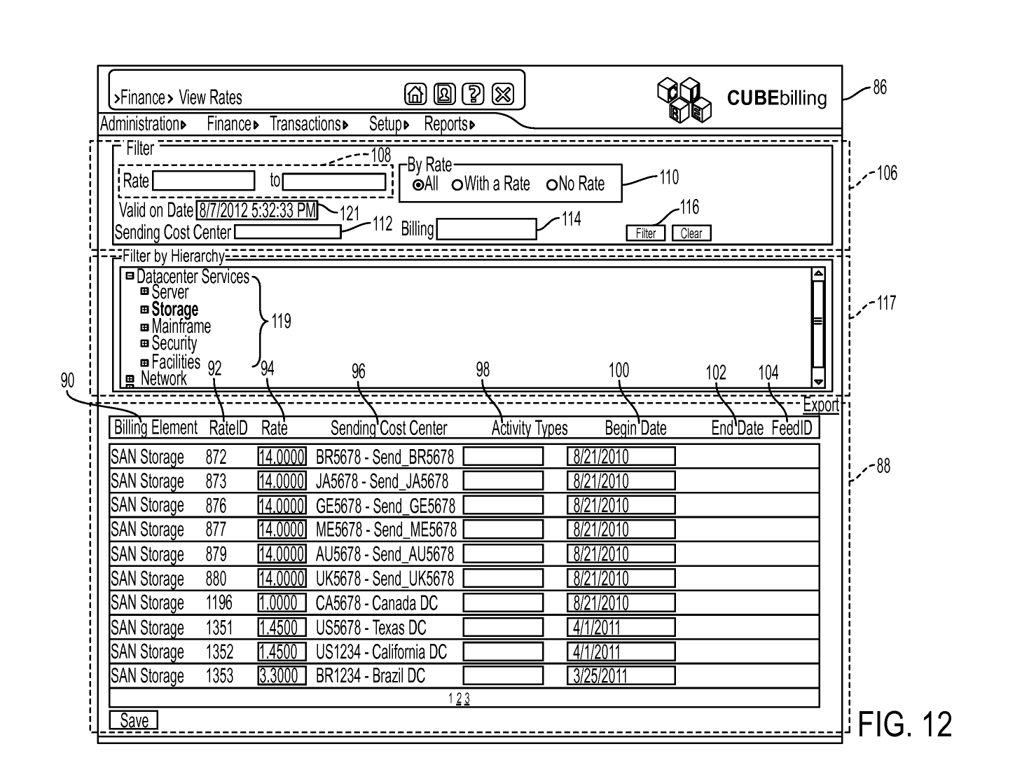

After the administrator user 14 enters the desired offerings descriptors in the offerings hierarchal module 28, the user may input into the system 10, the price or rate information related to each type of offering. In one embodiment, the rate module 29 of the system 10 generates a rate interface, such as the example rate interface 86 shown in FIG. 12. The rate interface 86 displays a rate section 88. The rate section 88 displays a plurality of columns for the following data fields: the offerings level 1 data field 90, the price or rate identification code field 92, the price or rate field 94, the provider level 1 data field 96, the activity type field 98, the begin date field 100, the end date field 102 and the feed identification field 104. Regarding the feed identification field 104, the system 10 enables the user to upload data files, such as Excel spreadsheets, which contain the rate data for the rate section 88. The system 10 assigns a unique identification, document ID or feedID for each such file. The column for the feed identification field 104 displays the feedIDs related to any such files uploaded by the user.

As shown in the example, the user can populate or fill these data fields with the rates and other information. It should be understood that different providers can have different rates for the same types of offerings. In the example shown, the provider, BR5678, has a rate of $14.00 for SAN Storage, and the provider, CA5678, has a rate of $1.00 for SAN Storage.

The rate interface 86 also displays a search or filter section 106. The filter section 106 includes a rate range field 108, a rate display setting 110, a provider search field 112 and a billing search field 114. In the billing search field 114, the user may enter the entire name, or part of the name, of the offering level 1 descriptor. The user may enter data into these fields and click the filter link 116. In response, the system 10 will filter and generate the results in the rate section 88. The user can enter a desired range of rates in the rate range field 108, such as $4.00 to $8.00. The user can also select the “All” option, “With a Rate” option or “No Rate” option of the rate display setting 110. The selected option determines whether the rate section 88 will display the rate-related data for all of the offerings, only for the offerings which have assigned rates, or only for the offerings with no assigned rates.

The hierarchal filter 117 of rate interface 86 displays all of the offering hierarchy descriptors 119 entered by the user through the offerings setup interface 76. The system 10 enables the user to select one or more of these descriptors 119. The system 10 filters the information displayed in the rate section 88 depending upon the user's selection of descriptors 119. For example, the user can select the Storage descriptor, a subset of the Datacenter Services descriptor. In response to that selection, the system 10 will display the rate-related information pertaining only to those offerings having the Storage descriptor. The system automatically populates the “Valid on Date” field 121 with the current date and time that the rate information is generated.

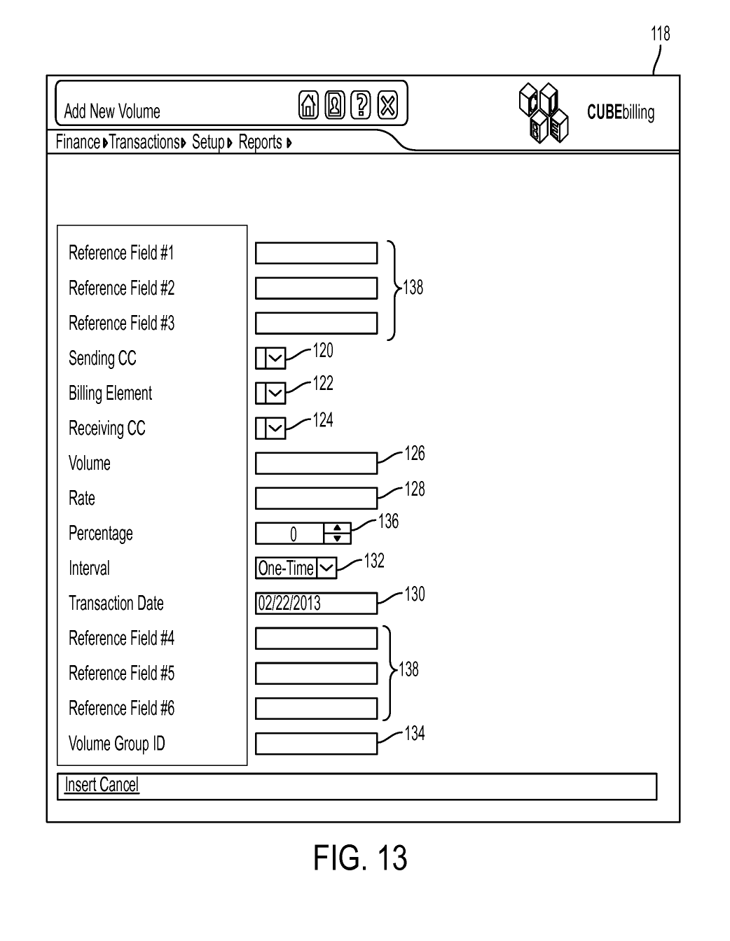

After the administrator user 14 enters the desired descriptors and rate information in the data collection modules 22, the system 10 enables the user to specify and initiate a transaction. In one embodiment, the system 10 includes a transaction interface, such as the example transaction interface 118 illustrated in FIG. 13. The transaction interface 118 includes the following data fields:
(a) provider level 1 field 120, fillable with the desired provider level 1 descriptor;
(b) offering level 1 field 122, fillable with the desired offering level 1 descriptor;
(c) receiving level 1 field 124, fillable with the desired receiver level 1 descriptor;
(d) volume field 126, fillable with the volume or quantity of offerings ordered;
(e) rate field 128, which will be automatically prefilled by the system based on the rate information input into the rate module 29, provided that the user may enter a desired rate in the rate field 128 to override the prefilled rate;
(f) transaction date or start date field 130, fillable with the date upon which the user wants the transaction to occur;
(g) interval field 132, selectable as “One-Time” or “Monthly,” if the user wants the transaction to automatically repeat on a periodic basis;
(h) end date field (not shown), fillable with the date upon which the repeating transaction will end;
(i) volume group ID field 134, selectable or fillable if the user wants the order to be shared and allocated amongst multiple receivers;
(j) percentage field 136, fillable with a desired percentage if the order is being allocated amongst multiple receivers, provided that if the use enters less than 100% in the percentage field 136, the system displays a second percentage field (not shown) fillable with the remaining percentage; and
(k) six variable fields or reference fields 138, fillable with identifiers, codes, tags or other information which the user might find useful, including, but not limited to, product serial number or offering nickname.

The system 10 enables the user to manually submit transactions through the transaction interface 118. The system 10 also enables the user to upload transactional data into the system by uploading data files, such as Microsoft Excel files, CSV files or text files. In one embodiment, the system 10 includes a suitable application programming interface (API) or plug-in which enables the system to automatically pull transactional data from an external database of the user's organization. In one embodiment, the system 10 implements an Extract, Transform, Load (ETL) method for automatically pulling such data.

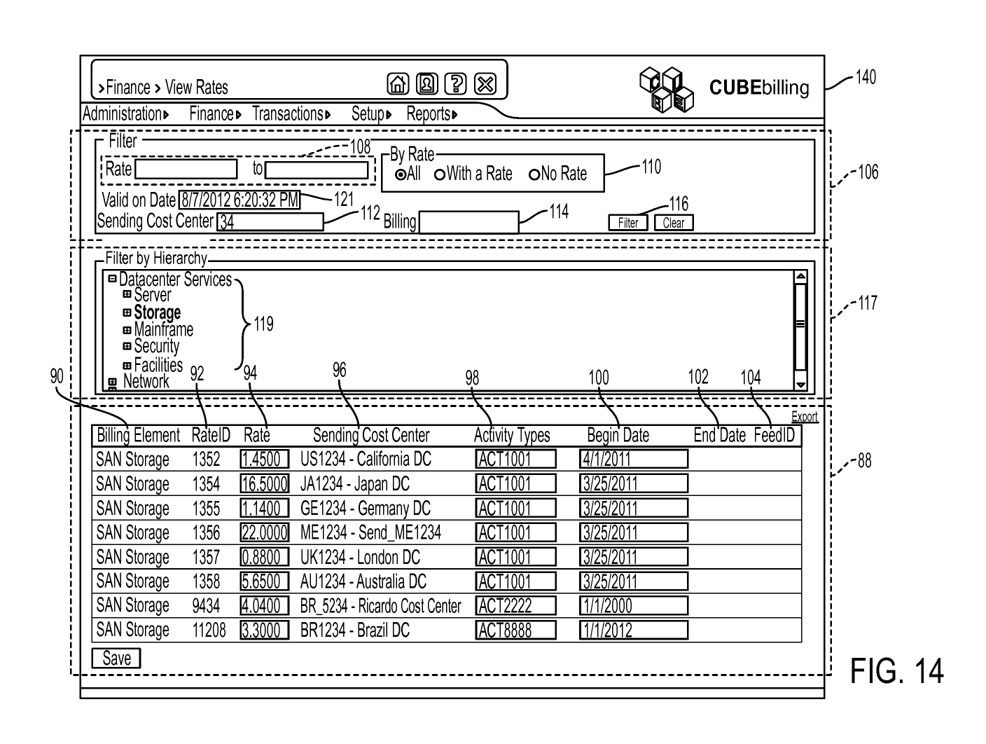

An organization might have its own financial management system for classifying and managing its offerings, including, but not limited to, an Enterprise Resource Planning (ERP) database or system, an accounting system such as Intuit® QuickBooks™ or any other suitable online or offline software program. In one embodiment, the organization's ERP system might have a unique ERP code for each different type of offering. In one embodiment, the organization's ERP codes are equivalent to the offerings level 1 descriptors. In the example interface 140 shown in FIG. 14, the offerings level 1 descriptor is SAN Storage. For the providers US1234, JA1234, GE1234, ME1234, UK1234 and AU1234, the ACT1001 code is the organization's ERP code which corresponds to SAN Storage. For the provider BR_{—}5234, the ACT2222 code is the organization's ERP code which corresponds to SAN Storage. For the provider BR1234, the ACT8888 code is the organization's ERP code which corresponds to SAN Storage. The ERP codes are displayed in the Activity Types column 98. When the system 10 generates reports and other visible output, as described below, the user can configure the output to display cost information in a format corresponding to the organization's ERP codes. This functionality facilitates integration with the organization's ERP databases and other financial management systems. In particular, the organization may parse and filter the system's cost information according to the organization's ERP codes or other identification codes.

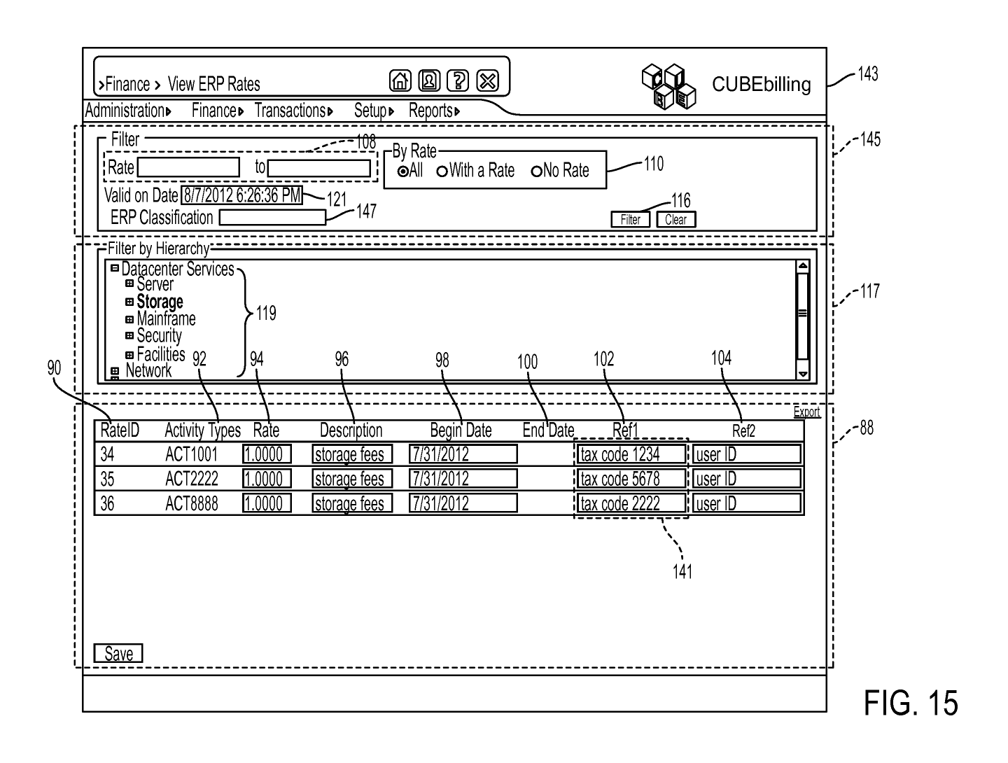

In one embodiment, the system 10 enables the user to enter ERP codes as the offering level 1 descriptors. In the example shown in FIG. 15, the user has input the ERP codes, ACT1001, ACT2222 and ACT8888. The system displays these ERP codes in the activity types column 142. These codes function as offering level 1 descriptors. The system 10 enables the user to input a price or rate for each one of the ERP codes. The system displays the rates in the rate column 94. As indicated in the rate identification column 92, the system 10 displays the rate identifications associated with the rates. The begin date column 100 displays the begin dates input by the user, and the end date column 150 displays the end dates, if any, input by the user.

In this example, the begin dates are the triggers for when the associated ERP codes will become active for generating transactions. The end dates are the dates upon which the system will stop using the associated ERP codes to generate transactions. The reference columns 152 display reference fields fillable by the user with additional, helpful codes and information, such as the tax code and user ID examples 141 of interface 143 shown in FIG. 15. In this example, the search section 145 has an ERP code search field. The user may enter an ERP code in section 147 to filter cost information based on the code entered.

As illustrated in FIG. 1, the system 10 is usable by a plurality of different categories of users, including administrator users 14, receiver users 16, provider users 18 and offering users 19. In one example, the organization is a hospitality company having a chain of hotels in California. The company has an internal department, a hotel supply center, located in California. The company's hotel supply center maintains a stock of shampoo, soap, towels, cleaning supplies, disposable eating utensils, signage, repair materials and other items. In this example, the hotel supply center is the provider, and each hotel is a receiver. For use of the system 10, the company may register one or more employees of its IT staff as administrator users 14. One or more of the employees working at the hotel supply center may register as provider users 18. One or more of the employees working at each hotel may register as receiver users 16. Also, the company may register certain employees, such as inventory or procurement managers, as offering users 19.

In one embodiment, the system 10 applies the user control logic 36, illustrated in FIG. 4, to generate four different user profiles with different degrees of authority. The following Table A describes these user profiles:

TABLE A

| User Profile | Authority | Role |
|---|---|---|
| Administrator | Setup, modify and | The administrator profile or |
| Profile | delete other users. | admin profile enables the |
| | Modify hierarchal | user to perform any and all |
| | descriptors. | functions of the system. |
| | Create transactions. | |
| | Perform any other | |
| | function of the system. | |
| Provider | View transactional data | The provider profile enables |
| Profile | for the one or more | the user to access |
| | provider entities | transactional data related to |
| | specified within the | the provider entities |
| | applicable provider | associated with the provider |
| | profile. | profile. |
| | Read-only access. | |
| | No authority to input | |
| | any changes or initiate | |
| | any transactions. | |
| Receiver | View transactional data | The receiver profile enables |
| Profile | for the one or more | the user to access |
| | receiver entities | transactional data related to |
| | specified within the | the receiver entities |
| | applicable receiver | associated with the receiver |
| | profile. | profile. |
| | Read-only access. | |
| | No authority to input | |
| | any changes or initiate | |
| | any transactions. | |
| Offering | View transactional data | The offering profile enables |
| Profile | for the one or more | the user to access |
| | offerings specified | transactional data related to |
| | within the applicable | the offerings associated with |
| | offering profile. | the offering profile. |
| | Read-only access. | |
| | No authority to input | |
| | any changes or initiate | |
| | any transactions. | |

The administrator of the organization may create a provider profile, receiver profile or offering profile for any person, whether the person is inside or outside of the organization. For example, an international company may have an auditor based in Canada. The Canadian auditor may have a provider profile, where only the company's Canadian providers are associated with auditor's profile. The procurement manager of the organization's business units in Florida may have a receiver profile, where only the Florida receivers are associated with the manager's profile. The organization's outside accountant may have an offering profile, where all of the organization's offerings worldwide are associated with the accountant's profile.

In one embodiment, the user control logic 36 includes a plurality of user profile options, including a transactional enhancement option and a financial enhancement option. The system 10 enables the administrator user to assign either or both of these options to any one of the user profiles. The transactional enhancement option enables the administrator to associate one or more transactions with a user's profile. The system 10 enables the user to generate, edit or delete the associated transactions. The financial enhancement option enables the user to generate and modify current and future rates associated with the offerings.

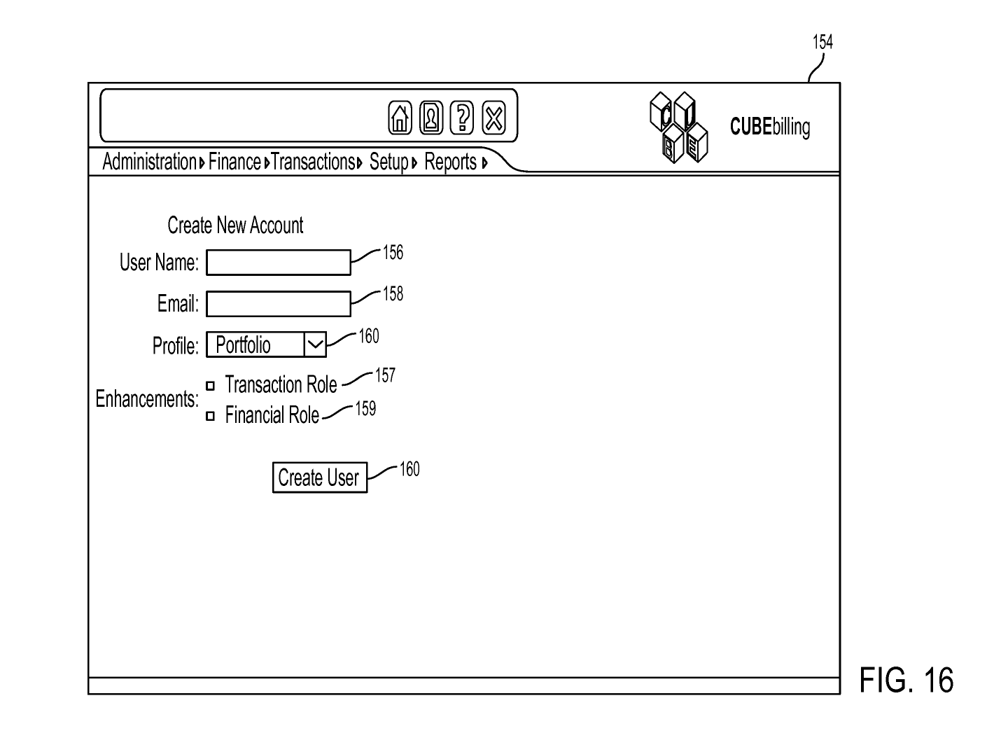

In one embodiment illustrated in FIG. 16, the system 10 generates the example wizard-type user setup interface 154. The setup interface 154 includes username and email fields 156 and 158, respectively. The pull-down menu 160 provides a plurality of profile types, including administrator, provider, receiver and offering profile types. In the example shown, the “Portfolio” selection indicates the offering profile type. The interface 154 also displays the selectable transactional enhancement option 157 and financial enhancement option 159. When the user selects the Create User link 160, the system 10 generates the new user profile.

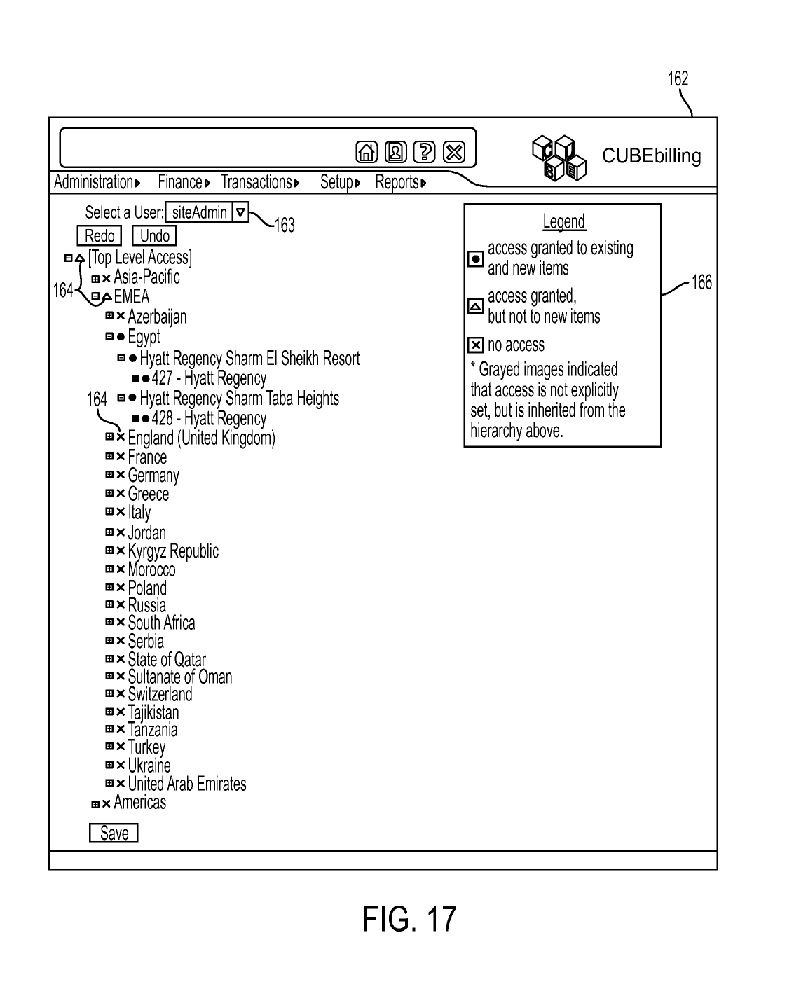

In one embodiment, the user control logic 36 is operatively coupled to, and dependent upon, the provider hierarchal module 24, receiver hierarchal module 26 and offerings hierarchal module 28. For each such module, the system generates an access control interface, such as the example access control interface 162 illustrated in FIG. 17. The access control interface 162 displays a user selection pull-down menu 163. To manage the privileges or authority of a subordinate user, such as a provider user or receiver user, the administrator user selects the subordinate user through the pull-down menu 163. The access control interface 162 displays the multiple levels of descriptors, from level 1 to level N, in a family tree format. The interface 162 has a fillable box 164 adjacent to each descriptor in the family tree. The system enables the administrator user to input a plurality of different settings for each box 164. As indicated by the legend 166, the administrator user may select a green checkmark or solid circle, yellow checkmark or solid triangle, or red X for the boxes 164.

If the administrator user selects the solid circle for a descriptor, the system associates that descriptor with the subordinate's user profile. The system 10 also associates with the subordinate's user profile, all of the filial descendants of that descriptor. In the example shown, the administrator user selected the green checkmark for the Egypt descriptor. As a result, the system automatically added the solid circles for the two children and two grandchildren of the Egypt descriptor. Accordingly, the user profile of the subordinate user provides access to the data associated with the Egypt descriptor as well as access to the data associated with the existing and future descriptors which are descendants of the Egypt descriptor.

If the administrator user selects the solid triangle for a descriptor, the system associates that descriptor with the subordinate's user profile. In the example shown, the administrator user selected the solid triangle for the EMEA descriptor. Accordingly, the user profile of the subordinate user provides access to the data associated with the EMEA descriptor but excludes access to any future descriptors which are descendants of the EMEA descriptor.

If the administrator user selects the red X for a descriptor, the system disassociates that descriptor from the subordinate's user profile. In the example shown, the administrator user selected the red X for a plurality of descriptors. Accordingly, the user profile of the subordinate user denies or blocks access to the cost information associated with such descriptors.

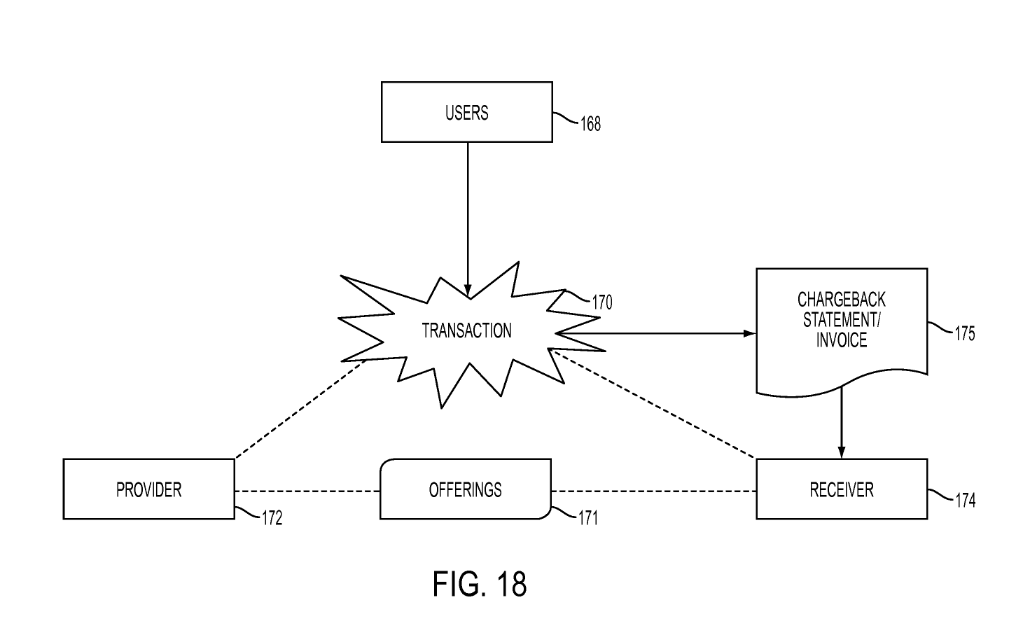

In one embodiment illustrated in FIG. 18, a user 168 has the authority to generate a transaction. In this example, the user 168 is employed by the hospitality company described above. First, the company inputs its descriptors and rates into the data collection modules 22. Next, the user 168 initiates a new transaction 170. The transaction 170 may include, for example, an order for offerings 171 of 5,000 bottles of shampoo to be delivered from the provider 172, the hotel supply center, to a receiver 174, a specified hotel. The system 10 processes the provider data, shampoo price, order quantity and receiver data to produce transactional cost information. This cost information allocates the cost to the receiver 174.

In this data processing step, the module coupling logic 32 operatively couples the modules 22 together. As a result, the transactional cost information is filterable according to the descriptors of the provider hierarchal module 24, receiver hierarchal module 26 and offerings hierarchal module 28. The system 10 is operable to generate a statement or invoice 175 for the specified hotel. The users at the hotel, users at the hotel supply center and the hospitality company's administrator users, all have network-based access to the transactional cost information.

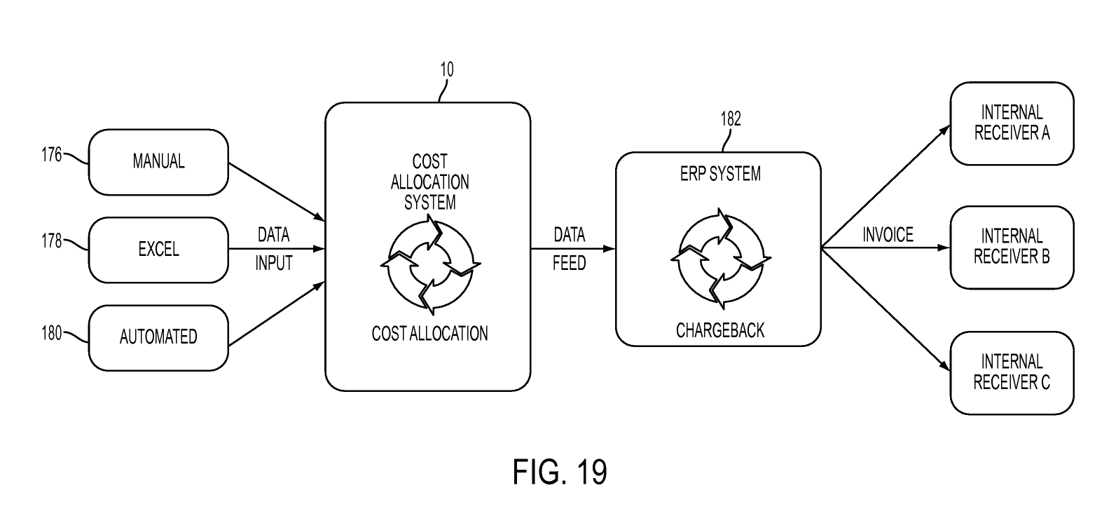

In one embodiment illustrated in FIG. 19, an organization loads into the system 10, the hierarchal descriptor data, rates, ERP codes and transactional data associated with one or more new transactions. The organization's administrator can load this data in a manual step 176 through the interfaces described above. Alternatively, the administrator can upload this data in Microsoft Excel format 178. For an automated method 180, using a suitable API, the system 10 can automatically pull this data from a database controlled by the organization.

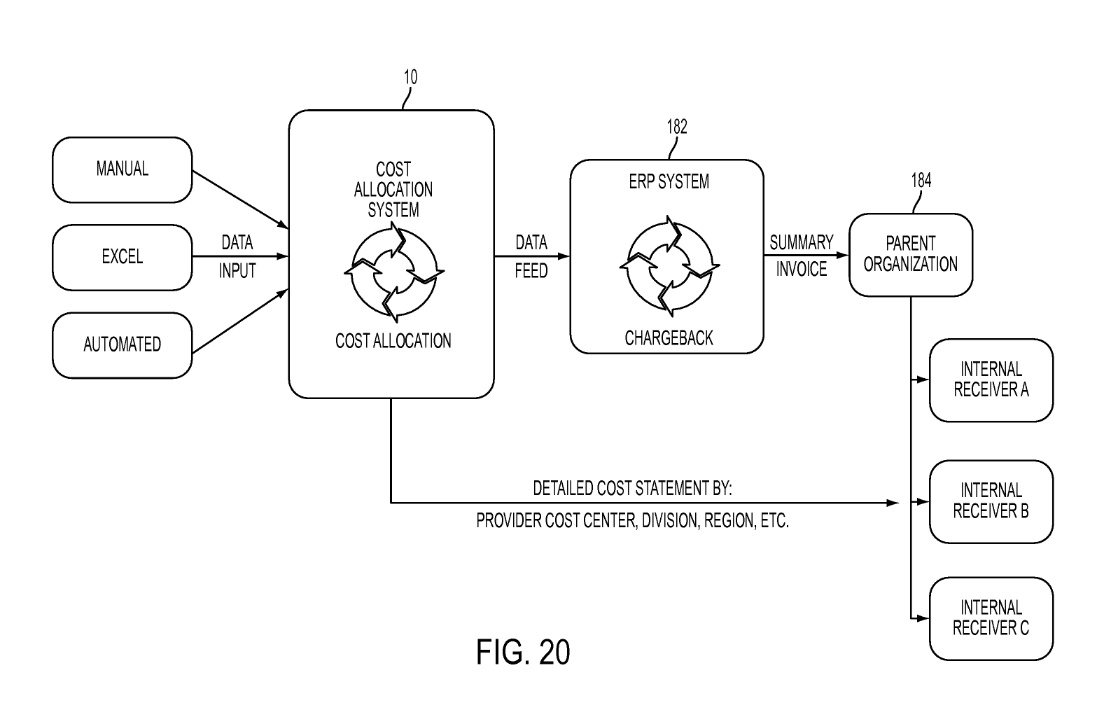

Once this data is loaded, the system 10 processes the data and generates transactional cost data. In the example shown, the system 10 loads the generated cost data into the organization's central financial system, ERP system 182, through the use of a suitable API. Since the system 10 incorporates the organization's ERP codes, the system 10 can send a fund request file, in the proper format, to the ERP system 182. Based on that file, the ERP system 182 can transfer the appropriate funds to pay the provider. Also, the ERP system 182 can send an invoice to the receivers A, B, and C. Alternatively, the ERP system 182 can send an invoice summary to the organization as illustrated in FIG. 20. The invoice summary can provide the total cost charged or incurred, summarizing the allocation of the cost amongst the internal receivers A, B and C. Also, for each type of offering ordered, the invoice summary can include the offering's name, ERP code, price, quantity, the provider's identity (i.e., the name or code of the organization's providing center or department), and the identities of the receivers (i.e., the names or codes of the receiving business units or departments of the organization).

As illustrated in FIG. 20, the system 10 can also generate internal bills, chargeback statements or detailed cost statements for the receivers A, B and C. The detailed cost statements are formattable to display itemized cost data including the organization's associated ERP codes. In one embodiment, the detailed cost statement summarizes the allocation of the cost amongst the internal receivers A, B and C. For each type of offering ordered, the cost statement can include the offering's name, ERP code, price, quantity, the provider's identity (i.e., the name or code of the organization's providing center or department), and the identities of the receivers (i.e., the names or codes of the receiving business units or departments of the organization). Depending upon the levels of descriptors and the data loaded, the detailed cost statement can include additional information regarding the provider and receivers.

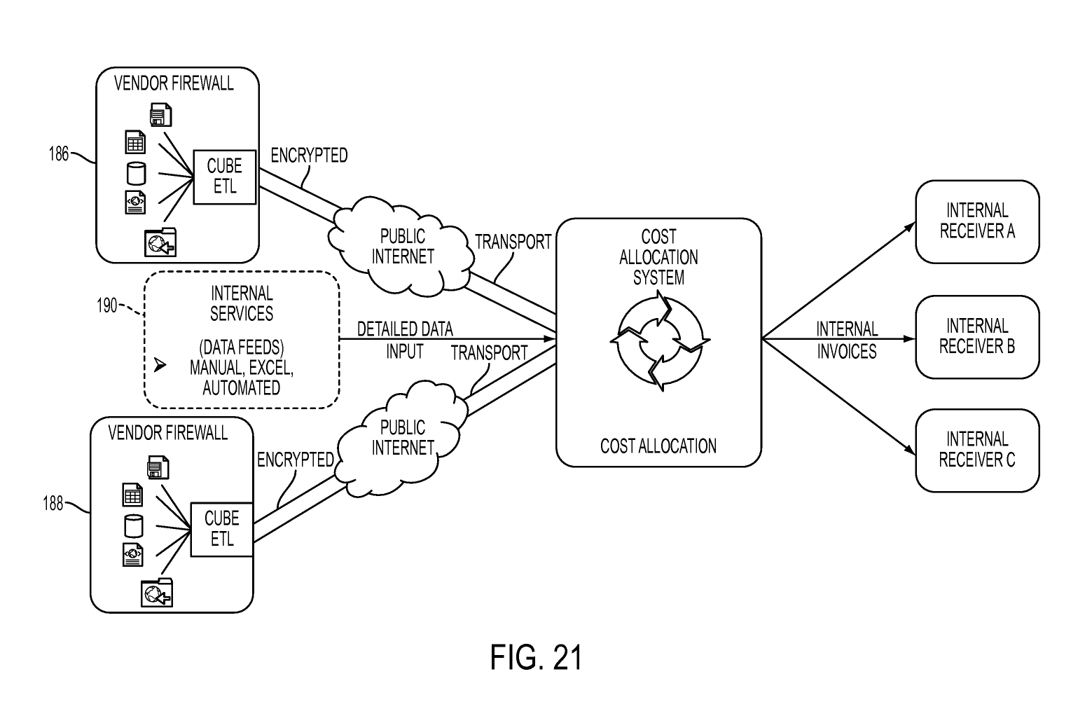

In some cases, an order from a receiver might require an external vendor to provide a product or service. For example, the receiver might order a laptop computer with a carrying case. The provider might have the computer in stock, but the provider might have to order the carrying case from a computer accessory vendor. In this scenario, the external vendor is treated as a provider. Therefore, the order involves two providers. In one embodiment illustrated in FIG. 21, the system 10 is operatively coupled to a plurality of vendor billing systems 186 and 188 over the network 13. Various methods 190 can be implemented to transfer transactional data from the vendor billing systems to the system 10, including, but not limited to, manual data entry by the vendors, manual uploading of data files, and automated transfer through a suitable API. Based on the transactional data supplied by the vendors, the system 10 generates invoices for the internal receivers A, B and C.

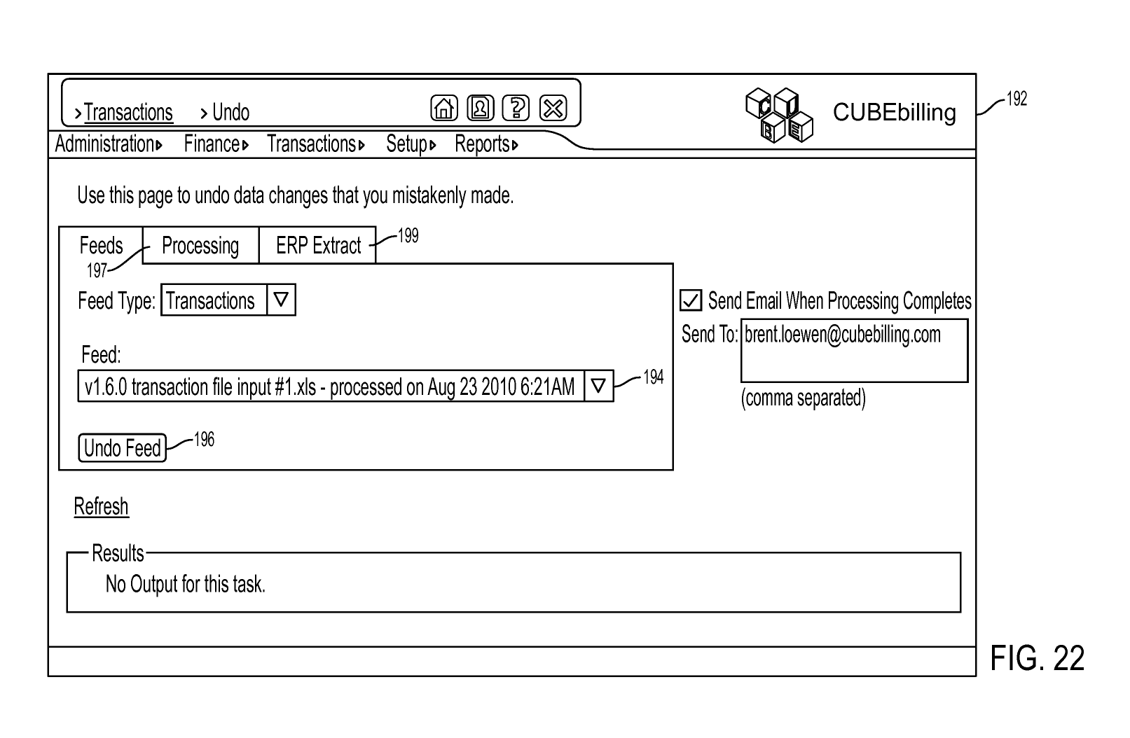

In one embodiment illustrated in FIG. 22, the system 10 includes a transaction modification module. The example transaction undo interface 192 has a pull-down menu 194. The pull-down menu 194 displays a list of the previously entered transactions which are pending and still cancellable or editable. The pull-down menu 194 enables the user to select one or more of the pending transactions for cancellation. When the user clicks the undo feed link 196, the system deletes the selected transaction and its associated data. The interface 192 also displays a send email section 196 including an option select box and an email field. The user may place a checkmark in the option select box and enter an email address in the email field. If the user does so, the system 10 automatically sends an email to that email address, notifying the recipient of the transaction cancellation. The processing tab 197, when selected, displays the pending transactions which are editable or cancellable. The ERP extract tab 199, when selected, displays the list of all extractable, pending ERP files. These files are scheduled to be transmitted, but the transaction modification module enables the user to edit them, stop them or replace them with new ERP files.

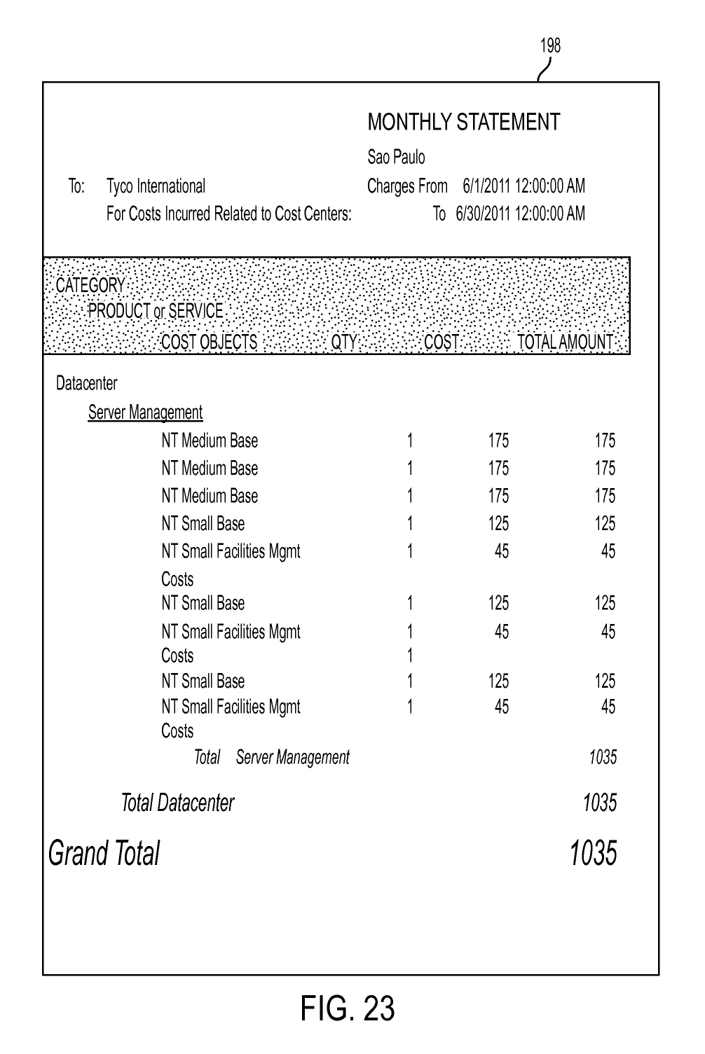

The system's reporting logic 34 enables the authorized users to generate a showback or chargeback statement, such as the example monthly statement 198 shown in FIG. 23. In this example, the statement 198 displays a line-by-line list of the different types of offerings ordered and the associated quantity, price or cost and total cost. The layout of the statement 198 organizes the lines in a family-tree format consistent with the hierarchal descriptor structure of the system. In the example shown, the receiver is Tyco, the provider is Datacenter, and the offerings include different types of server management services (at offerings level 1) within the Server Management category (at offerings level 2). The total monthly cost, allocated to Tyco for the server management services, is $1,035. Tyco may use this cost information to optimize the way of running its business.

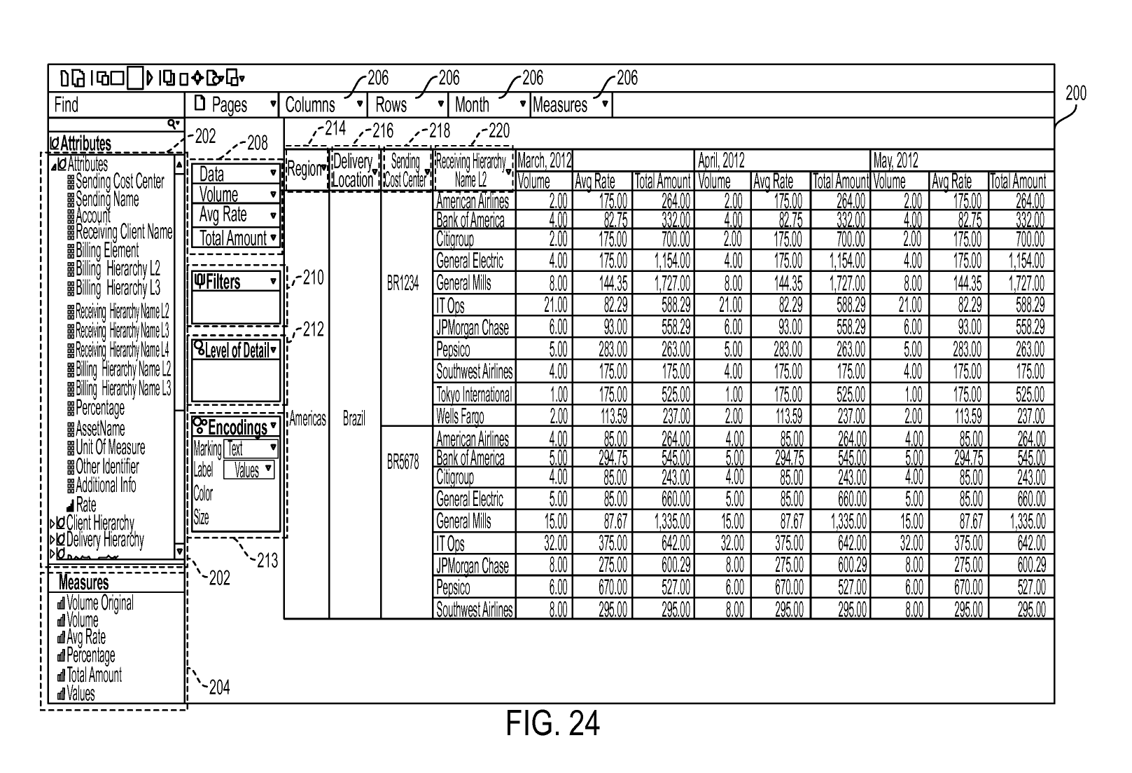

With network access to the system 10, the users can access the cost information on any day as frequently as desired. Based on the reporting logic 34, the system displays one or more reporting interfaces, such as the example reporting interface 200 shown in FIG. 24. In this example, the interface 200 includes: (a) a family-tree attribute list 202; (b) a measures list 204; (c) a plurality of format settings 206 for display configurations related to pages, columns, rows, month and measures; and (d) a plurality of filter sections, including a data filter section 208, filter section 210, level of detail filter 212, region filter 214, provider location filter 216, provider filter 218 and receiver filter 220.

The attribute list 202 displays a list of selectable hierarchy levels and reference fields associated with an order. The measures list 204 displays a list of selectable data types associated with an order, including the volume of the order, rate, allocation percentages, total cost or charge, and other order data. To prepare for generating cost output, the user clicks one of the attributes listed in list 202 and one of the measures listed in list 204. For example, the user may click and activate Billing Element in list 202 and Volume in list 204. Next, the user selects the desired format settings 206 to generate the cost output related to the Billing Element and Volume. The format settings 206 include display options for column format, row format, month and measures.

In the embodiment shown, the reporting interface 200 includes an encodings control section 213. The encodings control section 213 includes a plurality of graphical representation variables, including a text marking system, a labeling system, a color system and a size system. These systems provide visual aids for understanding, analyzing, and making decisions based upon, the cost data. For example, the color system includes a color gradient, where movement from light to dark represents cost increase. The size system includes size control, where the font size increases with increasing cost. In one embodiment, the reporting interface 200 combines the encodings control section 213 with a set of selectable types of symbols, charts and graphs to help empower business decisions and business intelligence.

The reports generated by the system are configurable to display the transaction date apart from the date of the statement or invoice. The transaction date corresponds to the date of consumption, that is, the date upon which the receiver received the ordered offering. This reporting function facilitates consumption forecasting, which depends on the consumption dates.

In one embodiment, the system has a communication module. The communication module enables a user to setup a plurality of different types of alerts or notices to be sent to specified users through email or text message. In one embodiment, the notices include a recurring alert about the availability of a chargeback statement, such as a monthly email having a link to a chargeback statement. In another embodiment, the notices are event-driven. For example, the system may send a text message alert to specified users when a transaction having a cost over $X has been initiated or when a transaction has been initiated for a specified receiver.

Methods

In one embodiment, the system 10 is implemented as a method. The method includes some or all of the functionality, steps and logic of the system 10. In one embodiment, the method involves a plurality of data fields stored within a data storage device. The data fields include a first level offering field, a second level offering field, a first level provider field, a second level provider field, a first level receiver field, a second level receiver field, and a plurality of price fields. A server or processor executes computer-readable instructions to perform the following method:
(a) receive a plurality of different offering descriptors, wherein each one of the offering descriptors is associated with a different type of offering, and wherein the offering descriptors include first and second offering descriptors;
(b) fill the first level offering field with the first offering descriptor;
(c) fill the second level offering field with the second offering descriptor;
(d) receive a plurality of different provider descriptors associated with a provider, wherein the provider is capable of providing the offering to a receiver, and wherein the provider descriptors include first and second provider descriptors;
(e) fill the first level provider field with the first provider descriptor;
(f) fill the second level provider field with the second provider descriptor;
(g) receive a plurality of different prices, wherein each one of the prices is associated with one of the types of offerings;
(h) fill each one of the price fields with one of the prices;
(i) receive a plurality of different receiver descriptors associated with the receiver, wherein the receiver descriptors include first and second receiver descriptors;
(j) fill the first level receiver field with the first receiver descriptor;
(k) fill the second level receiver field with the second receiver descriptor;
(l) receive a transaction request relating to a transaction in which one of the types of offerings is to be provided by the provider to the receiver;
(m) generate cost information in response to the transaction request; and
(n) display the cost information.

Network

Referring back to FIG. 1, the network 13 can be any suitable type of network. Depending upon the embodiment, the network 13 can include one or more of the following: a wired network, a wireless network, a local area network (LAN), an extranet, an intranet, a wide area network (WAN) (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth communication network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

Hardware

Referring back to FIG. 1, in one embodiment, the system 10 includes a single server. In another embodiment, the system 10 includes multiple servers, each of which implements a different part of the system 10. In one embodiment, each of the one or more servers includes: (a) a processor (such as the processor 40) or a central processing unit (CPU); and (b) one or more data storage devices (such as data storage device 20), including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), electrically erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

In one embodiment, each of the one or more servers is a general purpose computer. In one embodiment, the one or more servers function to deliver webpages at the request of clients, such as web browsers, using the Hyper-Text Transfer Protocol (HTTP). In performing this function, the one or more servers deliver Hyper-Text Markup Language (HTML) documents and any additional content which may be included, or coupled to, such documents, including, but not limited, to images, style sheets and scripts.

The network access devices 42 can include any device operable to access the network 13, including, but not limited to, a personal computer (PC) (including, but not limited to, a desktop PC, a laptop or a tablet), smart television, Internet-enabled TV, person digital assistant, smartphone, cellular phone or mobile communication device. In one embodiment, each network access device 42 has at least one input device (including, but not limited to, a touchscreen, a keyboard, a microphone, a sound sensor or a speech recognition device) and at least one output device (including, but not limited to, a speaker, a display screen, a monitor or an LCD).

In one embodiment, the one or more servers and network access devices each include a suitable operating system. Depending upon the embodiment, the operating system can include Windows, Mac, OS X, Linux, Unix, Solaris or another suitable computer hardware and software management system. In one embodiment, each of the network access devices has a browser operable by the processors to retrieve, present and traverse the following: (a) information resources on the one or more servers of the system 10; and (b) information resources on the World Wide Web portion of the Internet.

Software

In one embodiment, the computer-readable instructions, algorithms and logic of the system 10 (including the computer-readable instructions 38 and logic 30) are implemented with any suitable programming or scripting language, including, but not limited to, C, C++, Java, COBOL, assembler, PERL, Visual Basic, SQL Stored Procedures or Extensible Markup Language (XML). The data collection modules 22 of the system 10 can be implemented with any suitable combination of data structures, objects, processes, routines or other programming elements.

In one embodiment, the data storage device 20 of the system 10 holds or stores web-related data and files, including, but not limited, to HTML documents, image files, Java applets, JavaScript, Active Server Pages (ASP), Common Gateway Interface scripts (CGI), XML, dynamic HTML, Cascading Style Sheets (CSS), helper applications and plug-ins.

In one embodiment, the interfaces of the system 10 are Graphical User Interfaces (GUIs) structured based on a suitable programming language. The GUIs include, in one embodiment, windows, pull-down menus, buttons, scroll bars, iconic images, wizards, the mouse symbol or pointer, and other suitable graphical elements. In one embodiment, the GUIs incorporate multimedia, including, but not limited to, sound, voice, motion video and virtual reality interfaces.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A system comprising:
a data storage device accessible by a processor;
an offering module stored within the data storage device, the offering module specifying a plurality of levels of offering data fields organized in a hierarchal arrangement, each one of the offering data fields being fillable with an offering descriptor, the offering descriptors being associated with an offering;
a provider module stored within the data storage device, the provider module specifying a plurality of levels of provider data fields organized in a hierarchal arrangement, each one of the provider data fields being fillable with a provider descriptor, the provider descriptors being associated with a provider, the provider being capable of providing one or more of the offerings to a receiver;
a receiver module stored within the data storage device, the receiver module specifying a plurality of levels of receiver data fields organized in a hierarchal arrangement, each one of the receiver data fields being fillable with a receiver descriptor, the receiver descriptors being associated with the receiver; and
a plurality of instructions stored within the data storage device, the instructions being executable by the processor to: (a) receive at least one of the offering descriptors, at least one of the provider descriptors and at least one of the receiver descriptors; (b) receive a price; and (c) generate cost information.

2. The system of claim 1, wherein each one of the offerings is an item selected from the group consisting of a product and a service.

3. The system of claim 1, wherein one of the offering descriptors includes an offering identifier.

4. The system of claim 3, wherein the provider is a division of an organization, and the receiver is another division of the organization.

5. The system of claim 4, wherein: (a) one of the provider descriptors includes an identifier which identifies the provider as a division of the organization; and (b) one of the receiver descriptors includes another identifier which identifies the receiver as the another division of the organization.

6. The system of claim 1, wherein at least one of the instructions is executable by the processor to receive an offering quantity, the cost information being based, at least in part, on the offering quantity.

7. The system of claim 1, wherein at least one of the instructions is executable by the processor to receive an output request related to the cost information, the output request specifying at least one of a plurality of selectable filter settings, the plurality of selectable filter settings including: (a) an offering descriptor filter setting; (b) a provider descriptor filter setting; and (c) a receiver descriptor filter setting.

8. The system of claim 7, wherein at least one of the instructions is executable by the processor to generate a visible output in response to the output request, the visible output including the cost information in a format based on the at least one specified filter setting.

9. A system comprising:
a data storage device accessible by a processor;
a plurality of data fields stored within the data storage device, the data fields including a first level offering field, a second level offering field, a first level provider field, a second level provider field, a first level receiver field, a second level receiver field, and a price field; and
a plurality of instructions stored within the data storage device, the instructions being readable by the processor to cause the processor to operate with a display device and an input device to:
(a) receive an offering descriptor associated with an offering;
(b) fill the first level offering field with the offering descriptor;
(c) receive a provider descriptor associated with a provider, the provider capable of providing the offering to a receiver;
(d) fill the first level provider field with the provider descriptor;
(e) receive a price associated with the offering;
(f) fill the price field with the price;
(g) receive a receiver descriptor;
(h) fill the first level receiver field with the receiver descriptor;
(i) receive a transaction request relating to a transaction in which the offering is to be provided by the provider to the receiver;
(j) generate cost information in response to the transaction request; and
(k) display the cost information.

10. The system of claim 9, wherein the offering is an item selected from the group consisting of a product and a service.

11. The system of claim 9, wherein the offering descriptor includes an offering identifier.

12. The system of claim 11, wherein the provider is a first organization, and the receiver is a second organization, the second organization being a customer of the first organization.

13. The system of claim 11, wherein the provider is a division of an organization, and the receiver is another division of the organization.

14. The system of claim 13, wherein the division and the another division are each a part of the organization, the part being selected from the group consisting of a department, a business unit, a group, a center, an unincorporated division, an incorporated division, a subsidiary, a parent, an affiliated entity, an entity having a portion of its equity owned by the organization, a partner and a contractor.

15. The system of claim 9, wherein at least one of the instructions is executable by the processor to receive an output request related to the cost information, the output request specifying at least one of a plurality of selectable filter settings, the plurality of selectable filter settings including: (a) an offering descriptor filter setting; (b) a provider descriptor filter setting; and (c) a receiver descriptor filter setting.

16. The system of claim 15, wherein at least one of the instructions is executable by the processor to generate a visible output in response to the output request, the visible output including the cost information in a format based on the at least one specified filter setting.

17. A system comprising:
a data storage device accessible by a processor;
a plurality of data fields stored within the data storage device, the data fields including a first level offering field, a second level offering field, a first level provider field, a second level provider field, a first level receiver field, a second level receiver field, and a plurality of price fields; and
a plurality of instructions stored within the data storage device, the instructions being readable by the processor to cause the processor to operate with a display device and an input device to:
(a) receive a plurality of different offering descriptors, each one of the offering descriptors being associated with a different type of offering, the offering descriptors including a first offering descriptor and a second offering descriptor;
(b) fill the first level offering field with the first offering descriptor;
(c) fill the second level offering field with the second offering descriptor;
(d) receive a plurality of different provider descriptors associated with a provider, the provider capable of providing the offering to a receiver, the provider descriptors including a first provider descriptor and a second provider descriptor;
(e) fill the first level provider field with the first provider descriptor;
(f) fill the second level provider field with the second provider descriptor;
(g) receive a plurality of different prices, each one of the prices being associated with one of the types of offerings;
(h) fill each one of the price fields with one of the prices;
(i) receive a plurality of different receiver descriptors associated with the receiver, the receiver descriptors including a first receiver descriptor and a second receiver descriptor;
(j) fill the first level receiver field with the first receiver descriptor;
(k) fill the second level receiver field with the second receiver descriptor;
(l) receive a transaction request relating to a transaction in which one of the types of offerings is to be provided by the provider to the receiver;
(m) generate cost information in response to the transaction request; and
(n) display the cost information.

18. The system of claim 17, wherein the offering is an item selected from the group consisting of a product and a service.

19. The system of claim 17, wherein the provider is a first organization, and the receiver is a second organization, the second organization being a customer of the first organization.

20. The system of claim 17, wherein the provider is a division of an organization, and the receiver is another division of the organization.
